(19) United States
(12) Patent Application Publication
(10) Pub. No.: US 2009/0133380 A1
(43) Pub. Date: May 28, 2009

(54) Gas Turbine Engine

(75) Inventor: Stefan Donnerhack, Muenchen (DE)

Correspondence Address: Davidson, Davidson & Kappel, LLC, 485 7th Avenue, 14th Floor, New York, NY, 10018, US

(73) Assignee: MTU Aero Engines GmbH, Muenchen (DE)

(21) Appl. No.: 12/226,829

(22) PCT Filed: May 4, 2007
(86) PCT No.: PCT/DE2007/000801

§ 371 Date: Oct. 29, 2008

(30) Foreign Application Priority Data
May 9, 2006 (DE) 10 2006 021 436.6

(51) Int. Cl. F02C 7/10

(52) U.S. Cl. 60/39.511; 60/39.52; 60/299

(57) ABSTRACT

A gas turbine engine is described having at least one compressor, at least one combustion chamber, at least one turbine, and having an exhaust heat exchanger, which is used for returning waste heat of the exhaust emissions to the compressed combustion air prior to entry of the same into a combustion chamber. The exhaust heat exchanger is used as a substrate for catalysts for use in the catalytic aftertreatment of the exhaust emissions, in order to thereby reduce the pollutant emissions, in particular NOx emissions, of the gas turbine engine.

The present invention relates to a gas turbine engine according to the definition of the species set forth in claim 1.

Gas turbine aircraft engines known from the field have at least one compressor, at least one combustion chamber, as well as at least one turbine, at least one compressor being coupled in each case via one shaft to at least one turbine. Thus, gas-turbine aircraft engines having a three-shaft design are known, which have a low-pressure compressor configured as a fan, which is coupled via a first shaft to a low-pressure turbine. Besides the low-pressure compressor and the low-pressure turbine, which are coupled to one another via the first shaft, three-shaft engines also have a medium-pressure compressor, a high-pressure compressor, a high-pressure turbine, as well as a medium-pressure turbine, the medium-pressure compressor being coupled to the medium-pressure turbine via a second shaft, and the high-pressure compressor being coupled to the high-pressure turbine via a third shaft. Typically, these three shafts are concentrically nested within one another.

When it comes to reducing noise emissions and pollutant emissions, gas-turbine aircraft engines known from the related art have reached their conceptual limits. It is already a known practice when working with what are commonly known as fan gas-turbine aircraft engines, to reduce noise levels by setting a high bypass ratio and a low fan speed. This can be accomplished by coupling a gas-turbine aircraft engine fan, used as a low-pressure compressor, via a reduction gear to a high-speed low-pressure turbine. Noise emissions can be effectively reduced in this manner.

Efforts are currently directed to increasing the efficiency of gas-turbine aircraft engines known in the field, in order to reduce the noise emissions thereof. Thus, when working with a fan gas-turbine aircraft engine having a three-shaft design, it is already a known practice to position a heat exchanger downstream from the low-pressure turbine in order to remove waste heat from the exhaust emissions and to transfer the same to the air that has been compressed in the high-pressure compressor, prior to entry of the same into the combustion chamber. The efficiency of a gas turbine aircraft engine can be enhanced in this manner, thereby lowering the fuel consumption and ultimately making it possible to reduce pollutant emissions.

Against this background, an object of the present invention is to devise a novel gas turbine engine.

This objective is achieved by a gas turbine engine as set forth in claim 1. The present invention provides for the exhaust heat exchanger to be used as a substrate for catalysts used in the catalytic aftertreatment of the exhaust emissions, in order to thereby reduce the pollutant emissions, in particular NOx emissions, of the gas turbine engine.

Along the lines of the present invention, the exhaust heat exchanger is coated with a catalytically effective material in order to establish a catalytic exhaust-emissions aftertreatment in the gas-turbine aircraft engine. For the first time, a catalytic exhaust-emissions aftertreatment is provided in accordance with the present invention on gas-turbine engines, such as gas-turbine aircraft engines. Under known methods heretofore, such an exhaust-emissions aftertreatment on gas turbine aircraft engines was considered to be infeasible, since it could not be integrated into a gas-turbine aircraft engine. The present invention provides for integrating catalysts used in the catalytic aftertreatment of the exhaust emissions into the exhaust heat exchanger. This makes it possible to significantly reduce pollutant emissions, in particular NOx emissions.

Preferred embodiments of the present invention are derived from the dependent claims and from the following description. The present invention is described in greater detail in the following on the basis of exemplary embodiments, without being limited thereto. Reference is made to the drawing, whose:

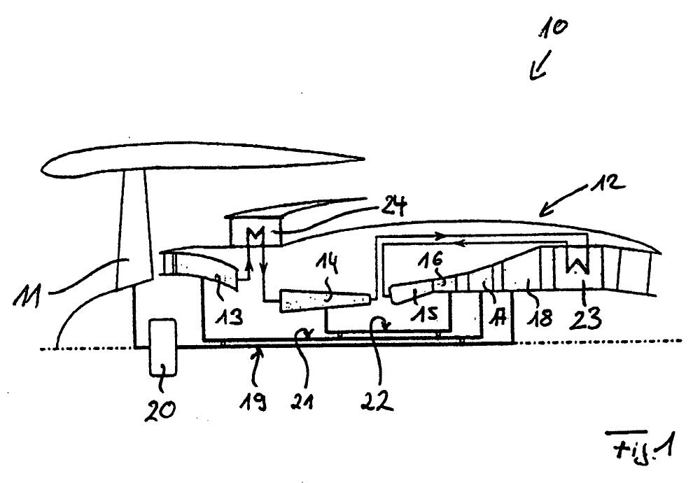

FIG. 1: shows a schematized representation of a gas turbine engine according to the present invention.

The present invention is described in the following with reference to FIG. 1 and based on the example of a gas-turbine aircraft engine 10 having a three-shaft design. Gas-turbine aircraft engine 10 of FIG. 1 has a fan 11 that functions as a low-pressure compressor, as well as a core engine 12 that is disposed downstream from fan 11 viewed in the flow direction of the air to be compressed, core engine 12 having a medium-pressure compressor 13, a high-pressure compressor 14, a combustion chamber 15, a high-pressure turbine 16, a medium-pressure turbine 17 and a low-pressure turbine 18. Fan 11 is coupled via a first shaft 19 to low-pressure turbine 18, namely via an interposed reduction gear 20.

Medium-pressure compressor 13 is coupled via a second shaft 21 to medium-pressure turbine 17. High-pressure compressor 14 is coupled via a third shaft 22 to high-pressure turbine 16. As is inferable from FIG. 1, the three shafts 19, 21 and 22 are concentrically nested within one another.

In accordance with FIG. 1, an exhaust heat exchanger 23 is configured downstream from low-pressure turbine 18. Exhaust heat exchanger 23 is traversed by the flow of the hot exhaust emissions exiting from low-pressure turbine 18 and transfers waste heat of the exhaust emissions to the combustion air that has been compressed in high-pressure compressor 14, namely prior to entry of the same into combustion chamber 15. Interposed between medium-pressure compressor 13 and high-pressure compressor 14 is an intercooler 24, which is used for cooling the combustion air that has been compressed in medium-pressure compressor 13 and, in fact, prior to entry of the same into high-pressure compressor 14.

Along the lines of the present invention, exhaust heat exchanger 23 is used as a substrate for catalysts for use in the catalytic aftertreatment of the exhaust emissions, in order to reduce the pollutant emissions, in particular NOx emissions, of gas-turbine aircraft engine 10. For this purpose, exhaust heat exchanger 23 is coated with a catalytically effective material on exhaust-routing surfaces. Accordingly, the present invention provides for a catalytic exhaust-emissions aftertreatment on a gas-turbine aircraft engine to be integrated in an exhaust heat exchanger of the same. Accordingly, the exhaust heat exchanger assumes two functions, namely, first of increasing the thermal efficiency of the gas-turbine aircraft engine by returning waste heat to the combustion air to be fed to combustion chamber 15, and, secondly, of preparing a catalytic exhaust-emissions aftertreatment to reduce pollutant emissions.

Exhaust heat exchanger 23 is preferably coated on its exhaust-routing surfaces with a catalytically effective metal or a catalytically effective metal alloy. However, other catalytically effective materials, such as plastics, for example, are also conceivable. The catalytically effective metal alloy contains at least platinum and/or palladium and/or rhenium, as well as preferably also at least one metal from the group of the rare earths. The metals of the rare earths include the chemical elements of the third subgroup of the periodic table, with the exception of actinium, and the lanthanoids. The metals of the rare earths include, in particular, yttrium and lanthanum.

Exhaust heat exchanger 23 is designed as a gas-gas heat exchanger having a relatively large surface area.

Exhaust heat exchanger 23 is preferably a lancet-shaped matrix heat exchanger, as known, in particular, from Examined Accepted European Specifications EP 0 328 043 B1 or EP 0 328 044 B1 or EP 0 313 038 B1. Lancet-shaped matrix heat exchangers of this kind have large gas-routing surface areas, namely, on the one hand, large exhaust-routing surface areas, and, on the other hand, large combustion air-routing surface areas, to allow heat to be effectively transferred from the exhaust emissions to the combustion air that has been compressed in high-pressure compressor 14. Accordingly, they also provide a large surface area for coating with catalytically effective materials.

In accordance with the present invention, a gas-turbine aircraft engine having a catalytic exhaust-emissions aftertreatment integrated into the same is provided for the first time.

1-10. (canceled)

11: A gas turbine engine comprising:
at least one compressor;
at least one combustion chamber;
at least one turbine; and
an exhaust heat exchanger, which is used to return waste heat of exhaust emissions to compressed combustion air prior to entry of the same into the at least one combustion chamber,
wherein the exhaust heat exchanger is used as a substrate for catalysts for use in the catalytic aftertreatment of the exhaust emissions, in order to thereby reduce the pollutant emissions of the gas turbine engine.

12: The gas turbine engine as recited in claim 11, wherein the pollutant emissions are NOx emissions.

13: The gas turbine engine as recited in claim 11, wherein exhaust-routing surfaces of the exhaust heat exchanger are coated with a catalytically effective metal or a catalytically effective metal alloy.

14: The gas turbine engine as recited in claim 13, wherein the catalytically effective metal alloy contains at least platinum and/or palladium and/or rhenium.

15: The gas turbine engine as recited in claim 14, wherein the catalytically effective metal alloy contains at least one rare earth metal.

16: The gas turbine engine as recited in claim 11, wherein the exhaust heat exchanger is configured downstream from the at least one turbine.

17: The gas turbine engine as recited in claim 11, wherein the gas turbine engine includes a compressor that is coupled via a first shaft and a gear to a low-pressure turbine, a medium-pressure compressor that is coupled via a second shaft to a medium-pressure turbine, and a high-pressure compressor that is coupled via a third shaft to a high-pressure turbine.

18: The gas turbine engine as recited in claim 17, wherein an intercooler is interposed between the medium-pressure compressor and the high-pressure compressor in order to cool air that has been compressed in the medium-pressure compressor prior to entry of the same into the high-pressure compressor.

19: The gas turbine engine as recited in claim 17, wherein the exhaust heat exchanger is configured downstream from the low-pressure turbine.

20: The gas turbine engine as recited in claim 11, wherein the exhaust heat exchanger is designed as a gas-gas heat exchanger.

21: The gas turbine engine as recited in claim 11, wherein the exhaust heat exchanger is designed as a lancet-shaped matrix heat exchanger.
